(19) United States
(12) Patent Application Publication
(10) Pub. No.: US 2023/0419214 A1
(43) Pub. Date: Dec. 28, 2023

(54) VEHICLE ALLOCATION MANAGEMENT APPARATUS AND VEHICLE ALLOCATION MANAGEMENT METHOD

(71) Applicant: JVCKENWOOD Corporation, Yokohama-shi (JP)

(72) Inventors: Tomoki Sakuragi, Yokohama-shi (JP); Junichi Kasuya, Yokohama-shi (JP); Kodai Nakamura, Yokohama-shi (JP)

(21) Appl. No.: 18/464,300

(22) Filed: Sep. 11, 2023

Related U.S. Application Data
(63) Continuation of application No. PCT/JP2022/011001, filed on Mar. 11, 2022.

(30) Foreign Application Priority Data
Mar. 12, 2021 (JP) 2021-040259

(51) Int. Cl. G06Q 10/0631

(52) U.S. Cl. CPC G06Q 10/06315

(57) ABSTRACT

A vehicle allocation management apparatus include: an acquisition unit that acquires parameter information on an automatic store desired by a user and location information on the user; an automatic store extraction unit that extracts, as a candidate automatic store to be allocated to the user, an automatic store with a predetermined positional relationship with the user based on the parameter and location information; and an automatic store determination unit that allocates, to the user, one candidate automatic store selected by the user from the candidate automatic stores. The parameter information includes information on a genre and/or a type of the automatic store, and the automatic store extraction unit further determines predetermined times for the genre and the type as the predetermined positional relationship, and extracts, as the candidate automatic store, the automatic store that can arrive at a place near a current location of the user within the predetermined time.

### CROSS-REFERENCE TO RELATED APPLICATIONS

This application is a Continuation of PCT International Application No. PCT/JP2022/011001 filed on Mar. 11, 2022, which claims the benefit of priority from Japanese Patent Application No. 2021-040259 filed on Mar. 12, 2021, the entire contents of both of which are incorporated herein by reference.

### FIELD OF THE INVENTION

The present disclosure relates to a vehicle allocation management apparatus and a vehicle allocation management method.

### BACKGROUND OF THE INVENTION

A vehicle allocation management system that acquires and monitors location information and state information on a commercial vehicle such as a taxi in which a global positioning system (GPS) and a communication apparatus are mounted, and allocates a vehicle that is traveling near a customer to a location at which the customer is waiting therefor is known (for example, see Japanese Laid-open Patent Publication No. 2002-190096).

Meanwhile, it may be possible to provide various kinds of services by using a self-driving vehicle. In this case, if a store of a self-driving vehicle (a vehicle which provides a service, hereinafter also called an automatic store) parked near a user is an automatic store which is unsuitable for a purpose of the user, it is desirable to be able to call a store desired by the user from the parked automatic store.

### SUMMARY OF THE INVENTION

A vehicle allocation management apparatus and a vehicle allocation management method are disclosed.

According to one aspect of the present application, there is provided a vehicle allocation management apparatus comprising: an acquisition unit configured to acquire parameter information on an automatic store that is desired by a user and location information on the user; an automatic store extraction unit configured to extract, as at least one candidate automatic store to be allocated to the user, at least one automatic store that has a predetermined positional relationship with the user based on the parameter information and the location information acquired by the acquisition unit; and an automatic store determination unit configured to allocate, to the user, one of the candidate automatic stores that is selected by the user from among the candidate automatic stores, wherein the parameter information includes information on at least one of a genre of the automatic store and a type of the automatic store, and the automatic store extraction unit is further configured to determine a predetermined time for each of the genre and the type as the predetermined positional relationship, and extract, as the candidate automatic store, the automatic store that is able to arrive at a place near a current location of the user within the predetermined time.

According to one aspect of the present application, there is provided a vehicle allocation management method executable by a computer comprising: acquiring parameter information on an automatic store that is desired by a user and location information on the user; extracting, as at least one candidate automatic store to be allocated to the user, at least one automatic store that has a predetermined positional relationship with the user based on the acquired parameter information and the acquired location information; and allocating, to the user, one of the candidate automatic stores that is selected by the user from among the candidate automatic stores, wherein the parameter information includes information on at least one of a genre of the automatic store and a type of the automatic store, and the extracting further comprising determining a predetermined time for each of the genre and the type as the predetermined positional relationship, and extracting, as the candidate automatic store, the automatic store that is able to arrive at a place near a current location of the user within the predetermined time.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a diagram illustrating a configuration example of a vehicle allocation management system according to a first embodiment;

FIG. 2 is a diagram illustrating an overview of the vehicle allocation management system according to the first embodiment;

FIG. 3 is a block diagram illustrating a configuration example of an automatic store terminal according to the first embodiment;

FIG. 4 is a flowchart illustrating an example of a flow of processes performed by the automatic store terminal according to the first embodiment;

FIG. 5 is a block diagram illustrating a configuration example of a vehicle allocation management apparatus according to the first embodiment;

FIG. 6 is a flowchart illustrating an example of a flow of processes performed by the vehicle allocation management apparatus according to the first embodiment;

FIG. 7 is a flowchart illustrating an example of a flow of vehicle allocation location determination processes performed by an automatic store according to the first embodiment; and

FIG. 8 is a diagram for explaining a method of determining a vehicle allocation location of the automatic store.

### DETAILED DESCRIPTION OF THE INVENTION

Embodiments of the present disclosure will be described in detail below with reference to the accompanying drawings. Meanwhile, the present disclosure is not limited by the embodiments below, and, in the embodiments below, the same components are denoted by the same reference symbols, and repeated explanation will be omitted.

### First Embodiment

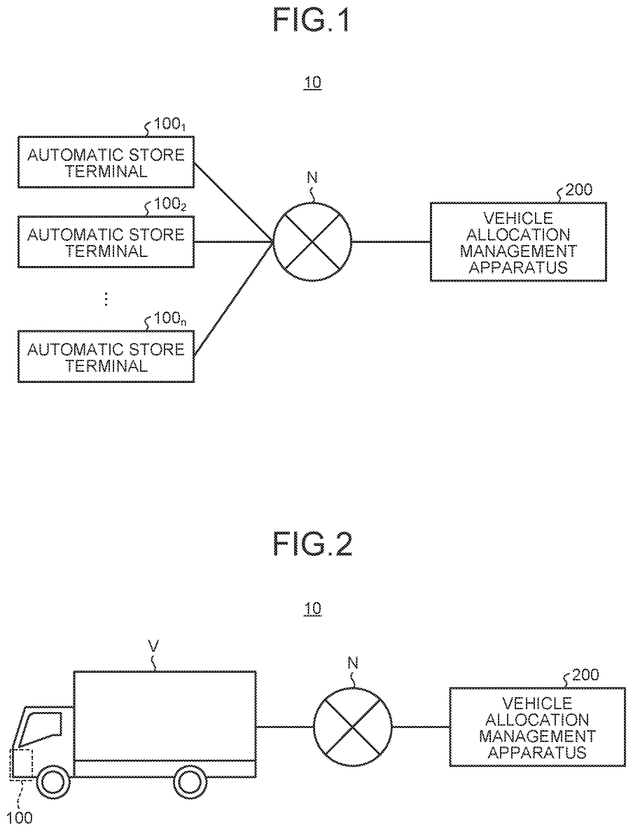

A vehicle allocation management system according to a first embodiment will be described with reference to FIG. 1 and FIG. 2. FIG. 1 is a diagram illustrating a configuration example of a vehicle allocation management system according to the first embodiment. FIG. 2 is a diagram illustrating an overview of the vehicle allocation management system according to the first embodiment.

As illustrated in FIG. 1, a vehicle allocation management system 10 includes an automatic store terminal 100₁, an automatic store terminal 100₂, . . . , an automatic store terminal 100ₙ (n is an arbitrary integer), and a vehicle allocation management apparatus 200. The automatic store terminal 100₁ to the automatic store terminal 100ₙ are communicably connected to the vehicle allocation management apparatus 200 via a network N. The automatic store terminal 100₁ to the automatic store terminal 100ₙ may be referred to as automatic store terminals 100 when they need not be specifically distinguished from one another.

The automatic store terminal 100 is arranged in an automatic store. It is preferable that the automatic store terminal 100 is arranged at a position at which the user can operate the automatic store terminal 100 from outside thereof. As illustrated in FIG. 2, the automatic store terminal 100 is arranged on, for example, a door of an automatic store V. The automatic store terminal 100 receives a desired condition for the automatic store from a user. Specifically, when the user finds an automatic store that is parked, and if the automatic store does not meet a condition desired by the user, the user is able to input a condition for a desired automatic store to the automatic store terminal 100 that is mounted on the found automatic store. The automatic store terminal 100 transmits the condition that is received from the user to the vehicle allocation management apparatus 200. The vehicle allocation management apparatus 200 receives the desired condition for the automatic store from the user, and allocates the automatic store. Meanwhile, it is assumed that the automatic store terminal 100 is arranged in the automatic store, but the present disclosure is not limited thereto. The automatic store terminal 100 need not always be arranged in the automatic store, but may be, for example, a portable communication terminal, such as a smartphone or a tablet.

Automatic Store Terminal

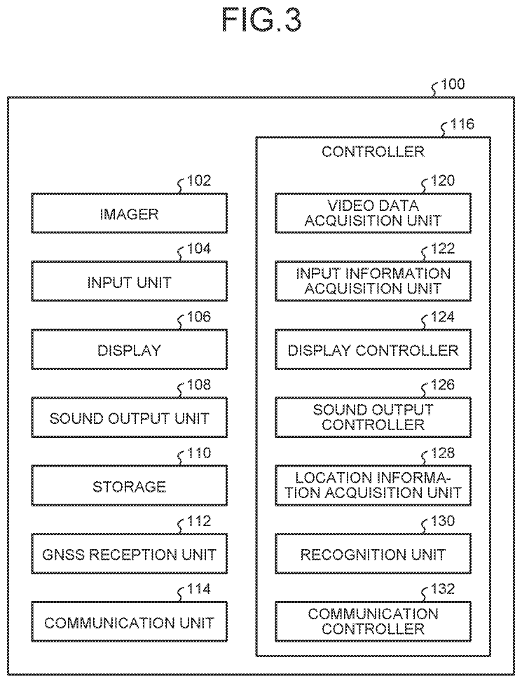

A configuration example of the automatic store terminal according to the first embodiment will be described with reference to FIG. 3. FIG. 3 is a block diagram illustrating a configuration example of the automatic store terminal according to the first embodiment.

As illustrated in FIG. 3, the automatic store terminal 100 includes an imager 102, an input unit 104, a display 106, a sound output unit 108, a storage 110, a global navigation satellite system (GNSS) reception unit 112, a communication unit 114, and a controller 116.

The imager 102 is arranged outside the automatic store, and captures an image, such as a face of the user or a photograph related to a service that the user wants to be provided from the automatic store. The imager 102 is composed of, for example, a visible light camera or an infrared camera. The imager 102 may be composed of, for example, a combination of a visible light camera and an infrared camera.

The input unit 104 is an input device that receives various kinds of operations on the automatic store terminal 100. The input unit 104 is composed of, for example, a button, a switch, a touch panel, or the like. The input unit 104 is composed of, for example, a microphone or the like that receives a voice from the user. The user is able to input parameter information on a desired condition for the automatic store to the input unit 104.

The display 106 displays various kinds of videos. The display 106 includes, for example, a display such as a liquid crystal display (LCD) or an organic electro-luminescence (EL) display. The display 106 is integrated with the input unit 104 when, for example, the input unit 104 is a touch panel.

The sound output unit 108 outputs various kinds of sounds. The sound output unit 108 is implemented by, for example, a speaker.

The storage 110 is a memory for storing various kinds of information. The storage 110 stores therein, for example, information such as calculation details or programs for the controller 116. The storage 110 includes at least one of a main storage device such as a random access memory (RAM) or a read only memory (ROM), and an external storage device such as a hard disk drive (HDD), for example.

The GNSS reception unit 112 receives GNSS signals that include information for identifying location information from a GNSS satellite (not illustrated). The GNSS reception unit 112 may be implemented by, for example, a GNSS reception circuit or a GNSS reception apparatus.

The communication unit 114 is a communication apparatus that transmits and receives various kinds of information between the automatic store terminal 100 and an external apparatus in a wireless manner. For example, the communication unit 114 transmits and receives information between the automatic store terminal 100 and the vehicle allocation management apparatus 200.

The controller 116 controls an operation of each of units of the automatic store terminal 100. The controller 116 is implemented by, for example, causing a central processing unit (CPU), a micro processing unit (MPU), or the like to execute a program stored in the storage 110 or the like by using a RAM or the like as a work area. The controller 116 may be implemented by, for example, an integrated circuit such as an application specific integrated circuit (ASIC) or a field programmable gate array (FPGA). The controller 116 may be implemented by a combination of hardware and software.

The controller 116 includes a video data acquisition unit 120, an input information acquisition unit 122, a display controller 124, a sound output controller 126, a location information acquisition unit 128, a recognition unit 130, and a communication controller 132.

The video data acquisition unit 120 causes the imager 102 to capture images. The video data acquisition unit 120 acquires video data from the imager 102.

The input information acquisition unit 122 acquires various kinds of input information. For example, the input information acquisition unit 122 acquires the input information that is input to the input unit 104 by the user. For example, the input information acquisition unit 122 acquires parameter information on the automatic store that is input to the input unit 104 by the user.

The display controller 124 causes the display 106 to display various kinds of information. The display controller 124 causes the display 106 to display an input screen, a selection screen, or the like in which the user inputs or selects various kinds of information, for example.

The sound output controller 126 causes the sound output unit 108 to output various kinds of sounds. The voice output controller 126 controls the sound output unit 108 and causes the sound output unit 108 to output sound information for the input screen and the selection screen displayed on the display 106.

The location information acquisition unit 128 acquires GNSS signals from the GNSS reception unit 112. The location information acquisition unit 128 calculates current location information on the automatic store terminal 100 based on the GNSS signals. For example, the location information acquisition unit 128 calculates a current location of the automatic store terminal 100 by earth coordinates.

The recognition unit 130 recognizes the user. The recognition unit 130 compares a video of the face of the user that is captured by the imager 102 and a video of the face of the user that is received from the vehicle allocation management apparatus 200, and determines whether the user is a user for whom the automatic store with the automatic store terminal 100 is allocated, for example.

The communication controller 132 causes the communication unit 114 to perform communication between the automatic store terminal 100 and an external apparatus. For example, the communication controller 132 causes the communication unit 114 to perform communication between the automatic store terminal 100 and the vehicle allocation management apparatus 200.

Details of Process

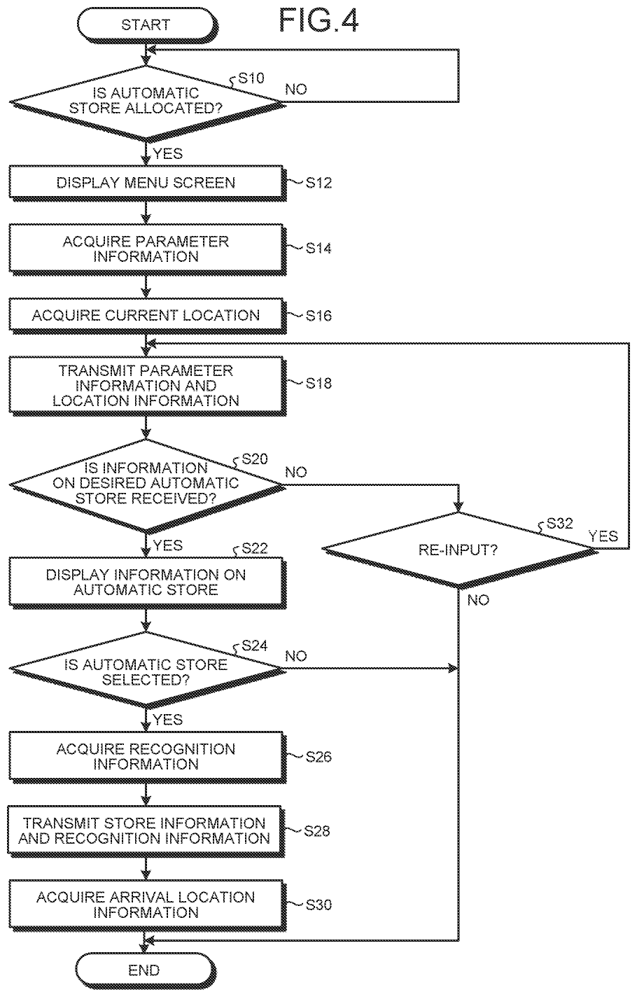

Details of a process performed by the automatic store terminal according to the first embodiment will be described below with reference to FIG. 4. FIG. 4 is a flowchart illustrating an example of a flow of processes performed by the automatic store terminal according to the first embodiment.

The controller 116 determines whether to allocate an automatic store (Step S10). Specifically, the controller 116 determines that the automatic store is to be allocated when an operation for allocating the automatic store is received from the user. The user is able to input the operation for allocating the automatic store to the input unit 104, for example. If it is determined that the automatic store is to be allocated (Step S10; Yes), the process proceeds to Step S12. If it is not determined that the automatic store is to be allocated (Step S10; No), the process at Step S10 is repeated.

If it is determined as Yes at Step S10, the controller 116 displays a menu screen (Step S12). Specifically, the display controller 124 causes the display 106 to display the menu screen that allows the user to select an automatic store, for example. Then, the process proceeds to Step S14.

The controller 116 acquires parameter information on the automatic store (Step S14). Specifically, the input information acquisition unit 122 acquires, as the parameter information, a genre of the automatic store, a type of the automatic store, the number of users, a use time, or the like. Examples of the genre of the automatic store include eating and drinking, a hospital, a toilet, and resting, but not limited thereto. Examples of the type of the automatic store include, in the case in which the genre of the automatic store is eating and drinking, a coffee shop, a lunch box, and fast food, but not limited thereto. If the input unit 104 is a touch panel or the like, the user is able to directly input the genre of the automatic store, the type of the automatic store, the number of users, the use time, or the like to the touch panel, for example. The user inputs the parameter information, such as “eating and drinking” as the genre of the store, a “coffee shop” as the type of the store, “two” as the number of users, and “30 minutes” as the use time, for example. If the input unit 104 is a microphone or the like, the user may input the genre of the automatic store, the type of the automatic store, the number of users, the use time, or the like by voice, for example. The user may input the type of the automatic store, the number of users, the use time, or the like by causing the imager 102 to capture an image or the like, for example. Further, the user may input, as the parameter information, an acceptable wait time until an arrival of the automatic store. Then, the process proceeds to Step S16.

The controller 116 acquires current location information on the automatic store terminal 100 (Step S16). Specifically, the location information acquisition unit 128 calculates the current location information on the automatic store terminal 100 based on GNSS signals received by the GNSS reception unit 112, for example. Then, the process proceeds to Step S18.

The controller 116 transmits the parameter information and the location information (Step S18). Specifically, the communication controller 132 transmits the parameter information acquired at Step S14 and the current location information on the automatic store terminal 100 acquired at Step S16 to the vehicle allocation management apparatus 200. Then, the process proceeds to Step S20.

The controller 116 determines whether information on the desired automatic store is received (Step S20). Specifically, the controller 116 determines whether the information on the automatic store corresponding to the parameter information acquired at Step S14 is received. If it is determined that the information on the desired automatic store is received (Step S20; Yes), the process proceeds to Step S22. If it is not determined that the information on the desired automatic store is received (Step S20; No), the process proceeds to Step S32.

If it is determined as Yes at Step S20, the controller 116 displays the information on the automatic store (Step S22). Specifically, the display controller 124 causes the display 106 to display the menu screen for selecting an automatic store corresponding to the information on the automatic store received at Step S20 from among the candidate automatic stores each of which is a candidate vehicle to be allocated. Then, the process proceeds to Step S24.

The controller 116 determines whether one of the automatic store displayed on the display 106 is selected (Step S24). Specifically, the input information acquisition unit 122 determines whether the user has selected one of the candidate automatic stores on the menu screen that is displayed on the display 106. If it is determined that one of the automatic stores is selected (Step S24; Yes), the process proceeds to Step S26. If it is not determined that one of the automatic store is selected (Step S24; No), the process in FIG. 4 is terminated.

If it is determined as Yes at Step S24, the controller 116 acquires recognition information (Step S26). Specifically, the video data acquisition unit 120 causes the imager 102 to capture, as the recognition information, an image of the face of the user such that another automatic store terminal mounted on the allocated automatic store can identify the user, for example. In other words, the recognition information may be video data of the face of the user. The controller 116 may issue an identification code or the like as the recognition information. Then, the process proceeds to Step S28.

The controller 116 transmits the store information and the recognition information (Step S28). Specifically, the communication controller 132 transmits the information on the automatic store selected at Step S24 and the recognition information acquired at Step S26 to the vehicle allocation management apparatus 200 via the communication unit 114. Then, the process proceeds to Step S30.

The controller 116 acquires arrival location information on the automatic store (Step S30). Specifically, the communication controller 132 acquires, from the vehicle allocation management apparatus 200, the arrival location information on the location at which the automatic store selected at Step S24 will arrive. The arrival location information indicates, for example, information indicating that the automatic store will arrive at the current location of the user. If, for example, the automatic store will not arrive at the current location of the user, the arrival location information indicates map information that indicates an arrival location. Then, the process in FIG. 4 is terminated. Meanwhile, when the automatic store arrives at the arrival location, the automatic store terminal 100 mounted on the arrived automatic store allows the user to use the arrived automatic store when the recognition information transmitted at Step S28 and video or the like of the face of the user match with each other as a result of matching. The user is able to pay a usage fee for the automatic store by an automatic adjustment machine.

If it is determined as No at Step S20, the controller 116 determines whether the user re-inputs the parameter information or the like (Step S32). Specifically, the input information acquisition unit 122 determines that re-inputting is performed when the user inputs the parameter information again. If it is determined that the re-inputting is performed (Step S32; Yes), the process proceeds to Step S18. If it is not determined that the re-inputting is performed (Step S32; No), the process in FIG. 4 is terminated.

Vehicle Allocation Management Apparatus

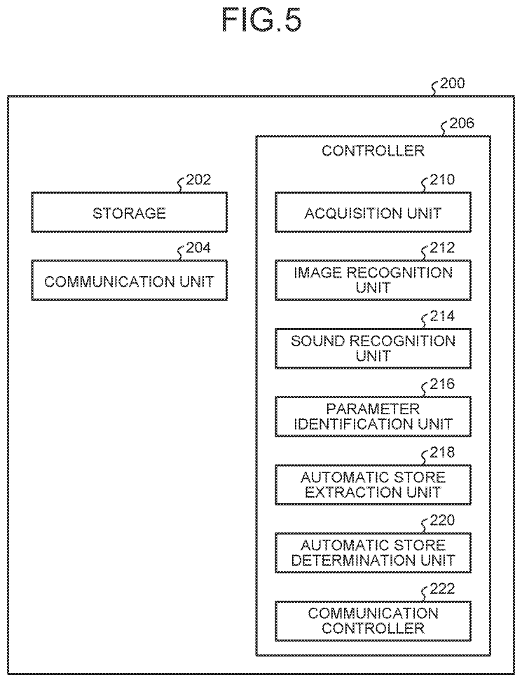

A configuration example of the vehicle allocation management apparatus according to the first embodiment will be described below with reference to FIG. 5. FIG. 5 is a block diagram illustrating a configuration example of the vehicle allocation management apparatus according to the first embodiment.

As illustrated in FIG. 5, the vehicle allocation management apparatus 200 includes a storage 202, a communication unit 204, and a controller 206. The vehicle allocation management apparatus 200 manages automatic stores of various genres, such as a restaurant, a hospital, a toilet, or a rest area. The vehicle allocation management apparatus 200 is configured to continuously acquire the location information on automatic stores managed by the vehicle allocation management apparatus 200.

The storage 202 is a memory for storing various kinds of information. The storage 202 stores therein, for example, information, such as calculation details or programs for the controller 206. The storage 202 includes at least one of a main storage device, such as a RAM or a ROM, and an external storage device, such as an HDD, for example.

The communication unit 204 is a communication apparatus that transmits and receives various kinds of information between the vehicle allocation management apparatus 200 and an external apparatus in a wireless manner. For example, the communication unit 204 transmits and receives information between the vehicle allocation management apparatus 200 and the automatic store terminal 100.

The controller 206 controls an operation of each of units of the vehicle allocation management apparatus 200. The controller 206 is implemented by, for example, causing a CPU, an MPU, or the like to execute a program stored in the storage 202 or the like by using a RAM or the like as a work area. The controller 206 may be implemented by, for example, an integrated circuit such as an ASIC or an FPGA. The controller 206 may be implemented by a combination of hardware and software.

The controller 206 includes an acquisition unit 210, an image recognition unit 212, a sound recognition unit 214, a parameter identification unit 216, an automatic store extraction unit 218, an automatic store determination unit 220, and a communication controller 222.

The acquisition unit 210 acquires various kinds of information. For example, the acquisition unit 210 acquires store information on the store selected by the user from the automatic store terminal 100 via the communication unit 204. The acquisition unit 210 continuously acquires the location information on each of the automatic stores managed by the vehicle allocation management apparatus 200, and stores the location information in the storage 202.

The image recognition unit 212 performs an image recognition process on the video data. For example, the image recognition unit 212 identifies parameters on the automatic store based on the video data acquired by the acquisition unit 210.

The sound recognition unit 214 performs a sound recognition process on the sound data. For example, the sound recognition unit 214 identifies parameters on the automatic store based on the sound data acquired by the acquisition unit 210.

The parameter identification unit 216 identifies parameters of the automatic store desired by the user. The parameter identification unit 216 identifies the parameters for identifying the automatic store based on the store information acquired by the acquisition unit 210, the parameters identified by the image recognition unit 212 based on the video data, and the parameters identified by the sound recognition unit 214 based on the sound data, for example.

The automatic store extraction unit 218 extracts at least one candidate automatic store to be allocated. For example, the automatic store extraction unit 218 searches for at least one automatic store that matches the parameter information from among the automatic stores. For example, the automatic store extraction unit 218 extracts, as the candidate automatic store to be allocated, the automatic store that matches with the parameter information.

The automatic store determination unit 220 determines the automatic store to be allocated to the user. The automatic store determination unit 220 determines, as the automatic store to be allocated, the automatic store selected by the user from among the candidate automatic stores to be allocated.

The communication controller 222 causes the communication unit 204 to perform communication between the vehicle allocation management apparatus 200 and an external apparatus. For example, the communication controller 222 causes the communication unit 204 to perform communication between the vehicle allocation management apparatus 200 and the automatic store terminal 100.

Details of Processes

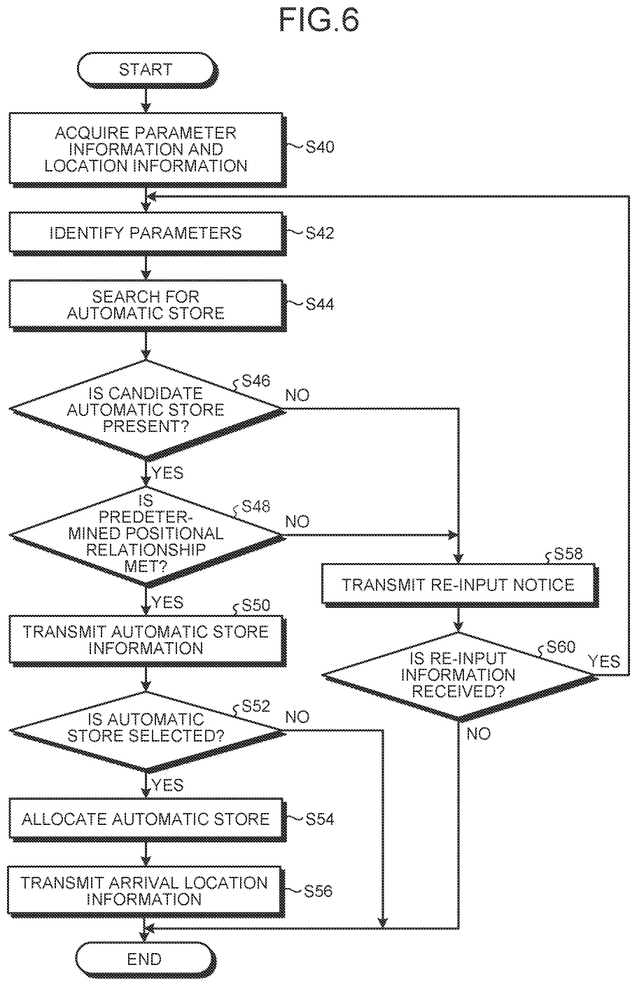

Details of processes performed by the vehicle allocation management apparatus according to the first embodiment will be described below with reference to FIG. 6. FIG. 6 is a flowchart illustrating an example of a flow of processes performed by the vehicle allocation management apparatus according to the first embodiment.

The controller 206 acquires the parameter information and the location information (Step S40). Specifically, the acquisition unit 210 acquires the parameter information on the automatic store desired by the user and the current location information on the automatic store terminal 100 from the automatic store terminal 100 via the communication unit 204. Then, the process proceeds to Step S42.

The controller 206 identifies parameters (Step S42). Specifically, the parameter identification unit 216 identifies parameters based on the parameter information that is input to the input unit 104 of the automatic store terminal 100 by the user and that is acquired by the acquisition unit 210, for example. If, for example, the user inputs the parameter information by video or the like, the parameter identification unit 216 identifies the parameters based on the image recognition process performed on the video data by the image recognition unit 212. If, for example, the user inputs the parameter information by voice, the parameter identification unit 216 identifies the parameter based on the sound recognition process performed on the sound data by the sound recognition unit 214. The parameter identification unit 216 identifies, for example, “eating and drinking” as the genre of the store, a “coffee shop” as the type of the store, “two” as the number of users, “30 minutes” as the use time, “voice” as a parameter input method, and the like. The parameter identification unit 216 identifies, for example, “eating and drinking” as the genre of the store, a “lunch box” as the type of the store, “three” as the number of users, “5 minutes” as the use time, a “touch panel” as the parameter input method, and the like. The parameter identification unit 216 identifies, for example, a “hospital” as the genre of the store, “internal medicine” as the type of the store, “one” as the number of users, “15 minutes” as the use time, “voice” as the parameter input method, and the like. The parameter identification unit 216 identifies, for example, “eating and drinking” as the genre of the store, “fast food” as the type of the store, “four” as the number of users, “60 minutes” as the use time, a “touch panel” as the parameter input method, and the like. In this manner, the parameter identification unit 216 identifies various parameters related to the automatic store that are input by the user. Then, the process proceeds to Step S44.

The controller 206 searches for an automatic store (Step S44). Specifically, the automatic store extraction unit 218 searches for an automatic store that matches with the parameters identified at Step S42 from among automatic stores that van be allocated by the vehicle allocation management apparatus 200. Then, the process proceeds to Step S46.

The controller 206 determines whether at least one candidate automatic store to be allocated is present as a candidate (Step S46). Specifically, the automatic store extraction unit 218 determines whether a candidate automatic store that matches with the parameters identified by the parameter identification unit 216 at Step S42 is present. If it is determined that the candidate automatic store to be allocated is present (Step S46; Yes), the process proceeds to Step S48. If it is determined that a candidate automatic store to be allocated is absent (Step S46; No), the process proceeds to Step S58.

If it is determined as Yes at Step S46, the controller 206 determines whether a current location of the automatic store to be allocated as the candidate and the current location of the user meet a predetermined positional relationship (Step S48). Specifically, the automatic store extraction unit 218 determines that the current location of the candidate automatic store to be allocated and the current location of the user meet the predetermined positional relationship based on the location information on the candidate automatic store to be allocated and the location information on the automatic store terminal 100 to which the user has input the parameter information. If, for example, a time until arrival of the candidate automatic store to be allocated is smaller than a predetermined time, the automatic store extraction unit 218 determines that the current location of the candidate automatic store to be allocated and the current location of the user meet the predetermined positional relationship. The predetermined time is determined in advance in accordance with the genre of the automatic store to be allocated, for example. Specifically, the automatic store extraction unit 218 compares an acceptable time X for arrival, which is set in advance for each genre of a store, and a time until arrival of the candidate automatic store to be allocated. The automatic store extraction unit 218 determines that the predetermined positional relationship is met if the time until arrival of the candidate automatic store to be allocated is smaller than the acceptable time X, and determines that the predetermined positional relationship is not met if the time until arrival of the candidate automatic store to be allocated exceeds the acceptable time X. The predetermined time may be determined in advance in accordance with the type of the automatic store to be allocated, for example. The predetermined time may be determined in advance in accordance with an average use time of the automatic store to be allocated, for example. For example, the predetermined time is set to a short time for an automatic store for which an average use time is short. Further, the automatic store extraction unit 218 may determine that the predetermined positional relationship is met if, for example, a distance between the candidate automatic store to be allocated and the current location of the user is smaller than a predetermined distance. If it is determined that the predetermined positional relationship is met between the candidate automatic store to be allocated and the current location of the user (Step S48; Yes), the process proceeds to Step S50. If it is not determined that the predetermined positional relationship is met between the candidate automatic store to be allocated and the current location of the user (Step S48; No), the process proceeds to Step S58.

If it is determined as Yes at Step S48, the controller 206 transmits automatic store information on the automatic store to the automatic store terminal 100 (Step S50). Specifically, the communication controller 222 transmits information on at least a single automatic store, for which it is determined that the predetermined positional relationship with the user is met at Step S48, to the automatic store terminal 100. Then, the process proceeds to Step S52.

The controller 206 determines whether the automatic store to be allocated is selected (Step S52). Specifically, if the information selected by the user by using the automatic store terminal 100 from among the pieces of automatic store information transmitted at Step S50 is acquired, the automatic store determination unit 220 determines that the automatic store is selected. If it is determined that the automatic store is selected (Step S52; Yes), the process proceeds to Step S54. If it is not determined that the automatic store is selected (Step S52; No), the process in FIG. 6 is terminated.

If it is determined as Yes at Step S52, the controller 206 allocates the automatic store (Step S54). Specifically, the automatic store determination unit 220 allocates the automatic store selected at Step S52 to the user. Then, the process proceeds to Step S56.

The controller 206 transmits the arrival location information to the automatic store terminal 100 (Step S56). Specifically, the automatic store determination unit 220 transmits the information on the location at which the automatic store allocated at Step S54 will arrive to the automatic store terminal 100. If, for example, the arrival location of the automatic store matches with the current location of the automatic store terminal 100, the automatic store determination unit 220 transmits information indicating that the locations match with each other to the automatic store terminal 100. If, for example, the arrival location of the automatic store does not match with the current location of the automatic store terminal 100, the automatic store determination unit 220 transmits the map information indicating the arrival location of the automatic store to the automatic store terminal 100. Then, the process in FIG. 6 is terminated.

If it is determined as No at Step S46 or if it is determined as No at Step S48, the controller 206 transmits a re-input notice to the automatic store terminal 100 (Step S58).

Specifically, if it is determined as No at Step S46, the automatic store extraction unit 218 transmits information indicating that an automatic store that meets the desired condition is absent. In this case, the automatic store terminal 100 displays the information indicating that an automatic store that meets the desired condition is absent and displays the menu screen for re-inputting the parameters. The automatic store terminal 100 may issue a query by voice about whether to re-input the parameter. For example, the automatic store terminal 100 may issue a query about whether to re-input the parameter by the same method as the method that the user has used to input the parameters.

Further, if it is determined as No at Step S48, the automatic store extraction unit 218 transmits information indicating that an automatic store that meets the desired condition is present but it is difficult to allocate the vehicle because it takes a long time before arrival. In this case, the automatic store terminal 100 displays the information indicating that it is difficult to allocate the vehicle because it takes a long time before arrival of the automatic store, and displays the menu screen for re-inputting the parameters. The automatic store terminal 100 may issue a query by voice about whether to re-input the parameters.

The controller 206 determines whether re-input information is received (Step S60). Specifically, after Step S58, if the parameter information on the automatic store that is desired by the user and the current location information on the automatic store terminal 100 are acquired from the automatic store terminal 100 via the communication unit 204, the acquisition unit 210 determines that the re-input information is received. If it is determined that the re-input information is received (Step S60; Yes), the process returns to Step S42. If it is not determined that the re-input information is received (Step S60; No), the process in FIG. 6 is terminated.

Vehicle Allocation Location Determination Method

The vehicle allocation management apparatus 200 may receive requests to allocate the same automatic store from multiple users within a predetermined time. In this case, the vehicle allocation management apparatus 200 determines a location at which the automatic store is to be allocated based on the location information on each of the users who have requested for allocation of the same automatic store.

Details of Process

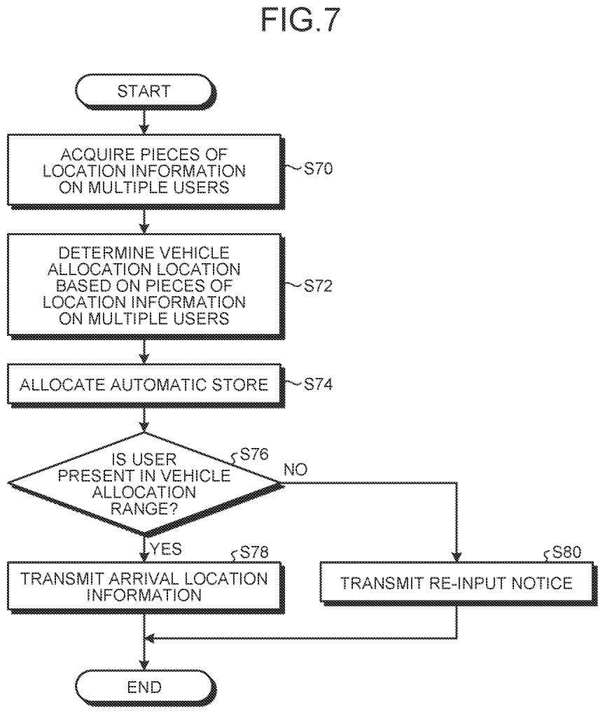

Vehicle allocation location determination processes performed by the automatic store according to the first embodiment will be described below with reference to FIG. 7. FIG. 7 is a flowchart illustrating an example of a flow of the vehicle allocation location determination processes performed by the automatic store according to the first embodiment. FIG. 7 illustrates processes performed after requests to allocate the same automatic store are received from multiple users within a predetermined time.

The controller 206 acquires pieces of location information on the multiple users (Step S70). Specifically, the acquisition unit 210 acquires, via the communication unit 204, location information on an automatic store terminal by which each of the users have requested for allocation of a desired vehicle, and acquires the pieces of location information on the multiple users. Then, the process proceeds to Step S72.

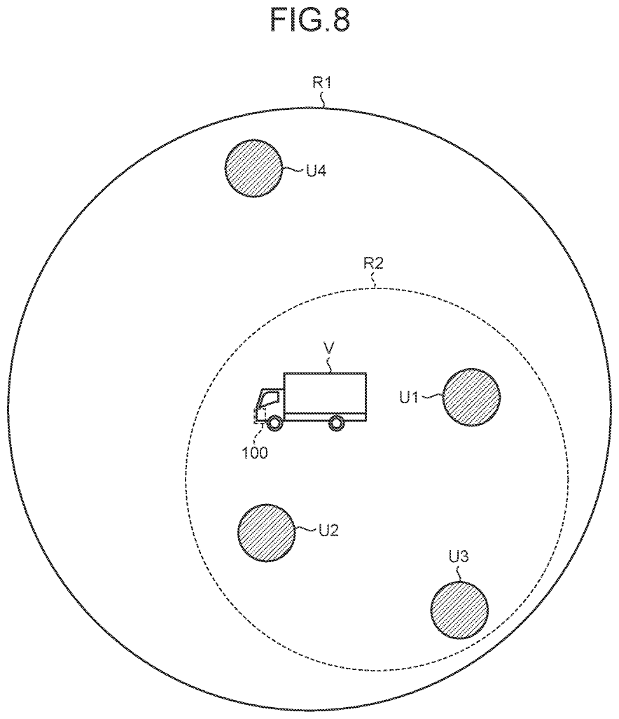

The controller 206 determines a vehicle allocation location of the automatic store based on the pieces of location information on the multiple users (Step S72). FIG. 8 is a diagram for explaining a method of determining the vehicle allocation location of the automatic store. The automatic store determination unit 220 sets a vehicle allocatable range R1 of an automatic store V in advance. The vehicle allocatable range R1 is set as a circle that is centered at a location of the automatic store V to be allocated and that has a radius of a first distance, but embodiments are not limited to this example. By setting the vehicle allocatable range R1, it is possible to allocate the automatic store V such that a time until arrival of the automatic store V falls within an acceptable range of the user. In the example illustrated in FIG. 8, it is assumed that a user U1, a user U2, a user U3, and a user U4 who are present in the vehicle allocatable range R1 of the automatic store V have requested for allocation of vehicles. To determine the vehicle allocation location, the automatic store determination unit 220 sets a vehicle allocation range R2 that is narrower than the vehicle allocatable range R1 in the vehicle allocatable range R1. The vehicle allocation range R2 is a circle with a radius of a second distance. In the example illustrated in FIG. 8, the vehicle allocation range R2 may be set as a circle, but embodiments are not limited to this example. The automatic store determination unit 220 moves the vehicle allocation range R2 in the vehicle allocatable range R1 and calculates a location in which the number of users included in the vehicle allocation range R2 among the multiple users is maximum. In the example illustrated in FIG. 8, the automatic store determination unit 220 calculates a location in which the user U1, the user U2, and the user U3 among the user U1 to the user U4 are included as the location in which the number of users included in the vehicle allocation range R2 is maximum. In this case, the automatic store determination unit 220 determines a location at the same distance from each of the user U1, the user U2, and the user U3 in the vehicle allocation range R2 as the vehicle allocation location, for example. By setting the vehicle allocation range R2, it is possible to allocate the automatic store V such that a distance by which the user needs to move falls within the acceptable range of the user. Meanwhile, the first distance of the vehicle allocatable range R1 and the second distance of the vehicle allocation range R2 may be set in accordance with the genre, the type, or the like of the automatic store V.

The controller 206 allocates the automatic store (Step S74). Specifically, the automatic store determination unit 220 allocates the automatic store at the location that is determined at Step S72. Then, the process proceeds to Step S76.

The controller 206 determines whether each of the users is a user who is present in the vehicle allocation range (Step S76). If it is determined that each of the users is a user who is present in the vehicle allocation range (Step S76; Yes), the process proceeds to Step S78. If it is not determined that the user is a user who is present in the vehicle allocation range (Step S76; No), the process proceeds to Step S80.

If it is determined as Yes at Step S76, the controller 206 transmits the arrival location information to the automatic store terminal 100 (Step S78). Specifically, the automatic store determination unit 220 transmits the information on the location at which the automatic store that is allocated at Step S74 will arrive to the automatic store terminal 100. More specifically, in the example illustrated in FIG. 8, the information on the location at which the automatic store will arrive is transmitted to the automatic store terminal 100 by which each of the user U1, the user U2, and the user U3 have requested for allocation of the automatic store. Then, the process in FIG. 7 is terminated.

If it is determined as No at Step S76, the controller 206 transmits the re-input notice to the automatic store terminal 100 (Step S80). Specifically, in the example illustrated in FIG. 8, the automatic store determination unit 220 transmits the re-input notice to the automatic store terminal 100 by which the user U4 has requested for allocation of the automatic store.

Specifically, if it is determined as No at Step S76, the automatic store extraction unit 218 transmits the information indicating that the automatic store that meets the desired condition is present but the vehicle allocation location is distant from the current location to the automatic store terminal by which the user U4 has requested for allocation of the automatic store.

As described above, according to the present embodiment, if an automatic store that is parked on the road is found, it is possible to allocate an automatic store that meets a desired condition of a user by inputting the parameter information to the automatic store terminal 100 that is mounted on the parked automatic store. Therefore, when the user finds an automatic store that is parked on the road, it is possible to more easily allocate a desired automatic store.

The components of the apparatuses illustrated in the drawings are conceptual function, and need not be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

According to one aspect of the present disclosure, it is possible to easily allocate an automatic store desired by a user.

Although the application has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The vehicle allocation management apparatus and the vehicle allocation management method according to the present application can be applied to an information processing device such as a computer.

What is claimed is:

1. A vehicle allocation management apparatus comprising:
an acquisition unit configured to acquire parameter information on an automatic store that is desired by a user and location information on the user;
an automatic store extraction unit configured to extract, as at least one candidate automatic store to be allocated to the user, at least one automatic store that has a predetermined positional relationship with the user based on the parameter information and the location information acquired by the acquisition unit; and
an automatic store determination unit configured to allocate, to the user, one of the candidate automatic stores that is selected by the user from among the candidate automatic stores, wherein
the parameter information includes information on at least one of a genre of the automatic store and a type of the automatic store, and
the automatic store extraction unit is further configured to determine a predetermined time for each of the genre and the type as the predetermined positional relationship, and extract, as the candidate automatic store, the automatic store that is able to arrive at a place near a current location of the user within the predetermined time.

2. The vehicle allocation management apparatus according to claim 1, wherein
when the acquisition unit acquires pieces of same parameter information from multiple users who are present in a vehicle allocatable range of the candidate automatic store, the automatic store extraction unit is further configured to extract one of the candidate automatic stores which is allocated to the multiple users, and the automatic store determination unit is further configured to determine a vehicle allocation location of the one of the candidate automatic stores which is allocated to the multiple users based on the location information on each of the users.

3. A vehicle allocation management method executable by a computer comprising:
acquiring parameter information on an automatic store that is desired by a user and location information on the user;
extracting, as at least one candidate automatic store to be allocated to the user, at least one automatic store that has a predetermined positional relationship with the user based on the acquired parameter information and the acquired location information; and
allocating, to the user, one of the candidate automatic stores that is selected by the user from among the candidate automatic stores, wherein
the parameter information includes information on at least one of a genre of the automatic store and a type of the automatic store, and
the extracting further comprising determining a predetermined time for each of the genre and the type as the predetermined positional relationship, and extracting, as the candidate automatic store, the automatic store that is able to arrive at a place near a current location of the user within the predetermined time.
